(19) United States
(12) Patent Application Publication
(10) Pub. No.: US 2013/0256999 A1
(43) Pub. Date: Oct. 3, 2013

(54) Basket-to-Frame Locking Clip

(71) Applicant: WESLEY McMURTREY, WAGONER, OK (US)

(72) Inventor: WESLEY McMURTREY, WAGONER, OK (US)

(73) Assignee: UNARCO INDUSTRIES, LLC, WAGONER, OK (US)

(21) Appl. No.: 13/433,928

(22) Filed: Mar. 29, 2012

(51) Int. Cl. B62B 3/02

(52) U.S. Cl. 280/33.991

(57) ABSTRACT

A shopping cart basket is attached to a frame having wheels using front and rear clips for attaching rim wires of a basket to a basket support member. The clips enable the basket to be assembled to the frame without requiring tools. A front clip is comprised of an upright body that is attached to the basket frame. A sloping surface on the clip urges a rigid wire of a basket sideways as the wire is moved downward. The rigid basket wire is captured into a rim wire receiving notch formed into the body. A rear clip receives two, joined-together wires when the two wires are oriented along their major dimension to fit into a slot that leads into a central figure-eight shaped lock.

### BACKGROUND

This invention relates to a shopping cart having a frame and basket with a bottom, walls and supported on a wheeled frame. Such baskets are well known, however, the basket part, which is made of a wire mesh, rigid rim wire, and a tubular frame, is assembled as a unitary piece by welding. After the basket components are welded together they are not easily packaged for shipment.

A problem with two-part baskets, i.e. a wire basket portion and a separate frame portion is that while they are more easily packaged together and packaged more compactly, assembling the separate parts so they stay assembled without welding has been problematic. A shopping basket made of two separate components, mainly the basket portion and the frame portion, that can be assembled after the components are shipped to a final destination in such a way that they stay assembled and do not come apart without welding would be an improvement over the prior art.

### BRIEF DESCRIPTION OF THE DRAWINGS

FIG. 1 is a side view of a two-part shopping part assembly;

FIG. 2 is a side view of an attachment clip for attaching a rear portion of a basket to a frame;

FIG. 3 is a side view of the clip shown in FIG. 2 and showing two, joined-together rim wires therein;

FIG. 4 is a perspective view of the clip shown in FIG. 2 with wires extending through the clip;

FIG. 5 is a perspective view of the clip shown in FIG. 2 attached to a basket support tube;

FIG. 6 is another side view of the clip shown in FIG. 2 with two joined-together rim wires oriented “upright,” i.e., with their major dimension being vertical;

FIG. 7 is a side view of an alternate embodiment of a clip for attaching the rear end of a basket to a frame;

FIG. 8 is a perspective view of a preferred embodiment of front clip for attaching a wire basket to a frame;

FIG. 9 is a perspective view of the front clip, as viewed from the rear of a basket toward the front of the basket;

FIG. 10A is a side view of the front locking clip;

FIG. 10B is a top view of the clip shown in FIG. 10A;

FIGS. 11A-11D depict the engagement of a rim wire into the rim wire receiving notch of the front clip shown in FIG. 7;

FIG. 12 shows the orientation of a front clip “reversed;” and

FIGS. 13A and 13B depict steps of assembling a wire basket to a frame.

### DETAILED DESCRIPTION

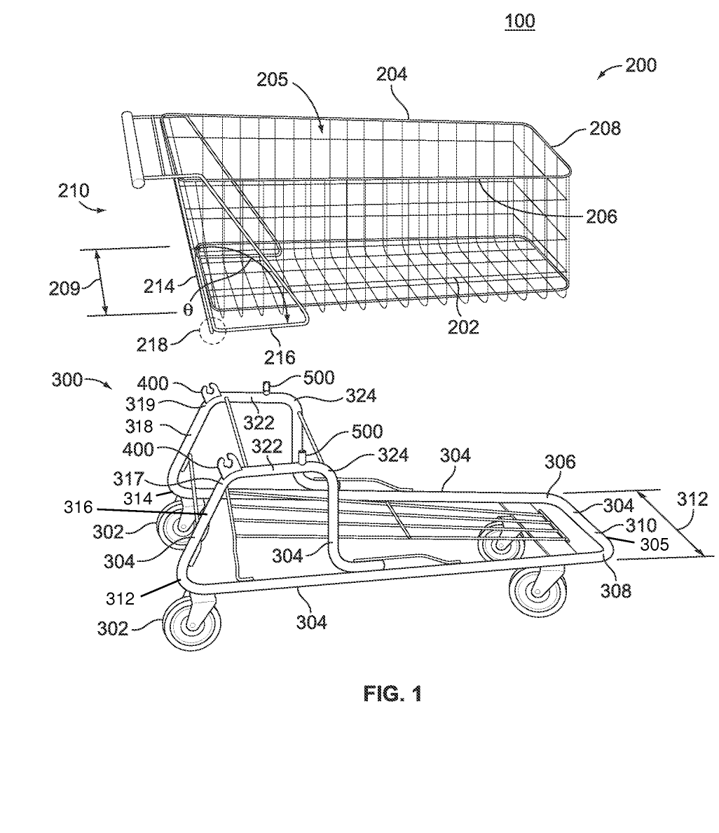

FIG. 1 is a perspective view of a two-part shopping cart assembly 100. A wire basket portion 200 is made from a relatively heavy gauge wire mesh. The basket portion 200, which is also referred to as the basket 200, has a wire mesh bottom 202 and two opposing wire mesh sides 204 and 206. The basket 200 also has a front end 208, an inclined back end 210 and an open top 205.

The wire mesh material forming the front, rear, sides and bottom is attached to a frame by at least two, relatively heavy gauge wires or rods 214 and 216. The two heavy-gauge wires 214 and 216 are attached to each other across the width 209 of the basket 200 and at bottom rear corner 218 where the wire mesh bottom 202 meets the wire mesh back end 210. One of the two, joined-together wires 214 and 216 bends forwardly at the lower rear corners 218 of the basket 200 to form what is considered herein to be a “horizontal” basket rim wire 216. The other wire 218 extends upward to define the back end 210 and its angle relative to the horizontal bottom.

The back end 210 and the rim wire 214 supporting or defining it is inclined, relative to the bottom 202 of the basket 200 and the forwardly-extending horizontal rim wire 216. The angle between the back 210 and the horizontal rim wire 216 is an angle θ, which is determined by the connection of the two wires 214 and 216 to each other.

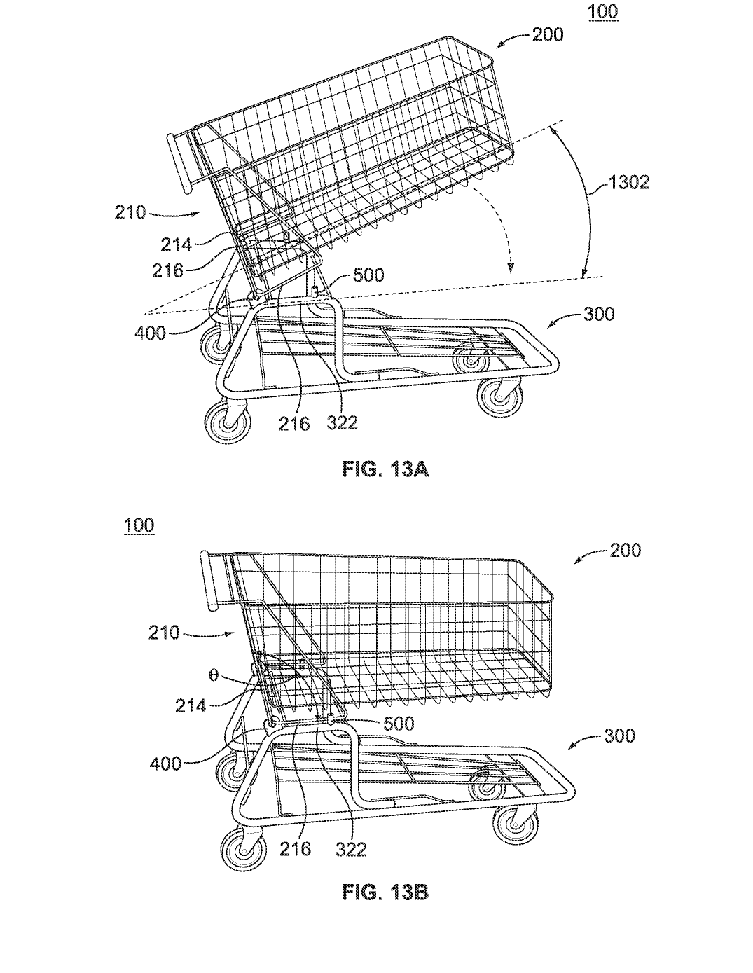

The connection between the two wires 214 and 216 are configured such that when the basket 200 is rotated counterclockwise, i.e., such that the plane of the bottom is inclined as shown in FIG. 13, the two, joined-together rim wires 214 and 216 are able to slide into slot-like openings of two, rear locking clips 400 attached to the frame 300. After the wires 214 and 216 are lowered into the slots of the rear locking clips 400, the wires 214 and 216 can be “rotated” in the clips, through a limited angle, as the basket is rotated clockwise. The rear clips 400 thus lock the rim wires to the basket but provide “rotatability” to the wires. Wire rotation stops in the clips 400, the angle θ between the wires, and an angle between a frame mounting tube, and the wire's physical characteristics determine the force required to drive the basket 200 clockwise to engage a front clip. One of the two rim wires 216 that forms the horizontal rim wire 216 extends forward from the lower rear corners 218 and latched into a forward clip that is also attached to the frame.

The frame portion or frame 300 is mounted onto wheels 302. They allow the assembled two-part shopping cart 100 to be wheeled about.

The frame 300 is comprised of an elongated tube 304 bent to form a front bar 305 between two front corners 306 and 308. The tube 304 extends rearward from the two front corners 306 and 308 to where the tube 304 is bent upwardly to form two upwardly-oriented rear corners 312 and 314. The tube 304 extends upward from the rear corners 312, 314 to form upright portions 316 and 318. The portion of the tube 304 forming the upright portions 316 and 316 is bent again at two corners 317 and 319 to form substantially horizontal basket-supporting tube portions 322.

The basket 200 and the frame 300 are attached to each other by two rear clips 400 and two front clips 500. The rear clips 400 are attached to the horizontal basket-supporting tube portions 322, at or near the corners identified by reference numerals 318 and 320. The front clips 500 are attached near the forward ends 324 of the horizontal basket-supporting tube portions 322.

The rear clips 400 are configured to allow the basket 200 to be rigidly attached to the frame 300 without welding. Several separate basket portions can thus be stacked inside of each other for shipment, i.e., with the bottom of one basket portion placed into the open top of another basket portion. Several frame portions can also be stacked with one atop another for shipment. When the separate baskets and frames arrive at a destination, the clips 400 and 200 allow the separate pieces to be securely attached to each other without welding and without tools.

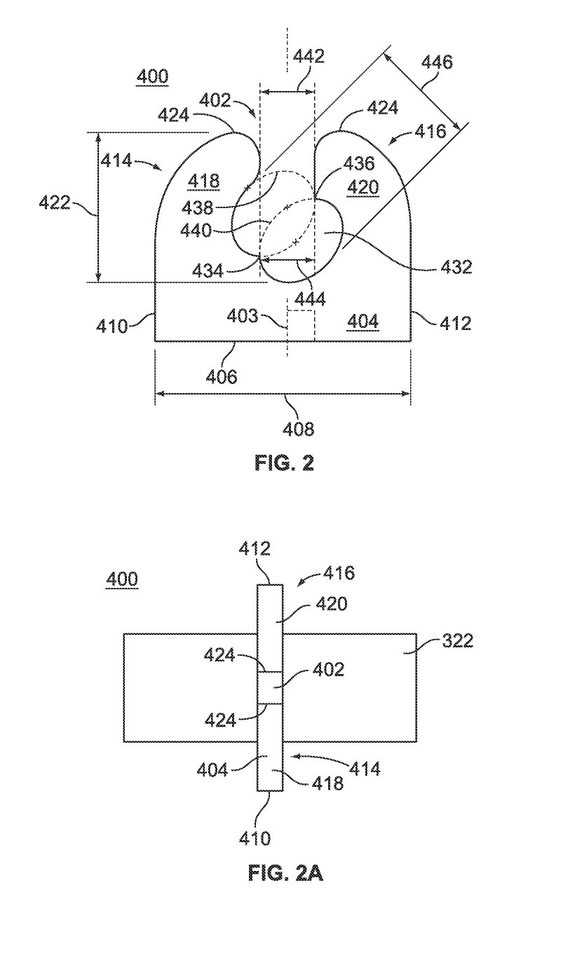

FIG. 2 is a side view of a rear clip 400. FIG. 2A is a top view of the clip shown in FIG. 2, attached to a portion of the horizontal basket-supporting tube 322.

As it is shown in FIG. 2, the clip 400 side view has an exterior shape reminiscent of the Arabic letter “C” rotated with the opening 402 facing upward. For brevity as well as claim-construction purposes, the rear clip 400 is considered to be “C-shaped.”

As shown in FIGS. 2 and 2A, the rear clip 400 is comprised of a relatively thick metal body 404 with a flat bottom 406, a width defined by the distance 408 between two opposing left and right sides 410, 412. Both sides 410, 412 have top portions 414, 416, which curve inwardly toward each other forming opposing lobes 418, 420. The sides 410, 412, have a nominal height 422 defined by the distance from the bottom 406 to the highest points 424 on the two opposing lobes 418, 420.

The tab 200 could be rectangular, i.e., without having curves that form the lobes but such a shape would then have corners on which a person might be cut. The lobe portions 418, 420 are thus advantageous in that they tend to reduce or eliminate the likelihood of someone being cut by a relatively sharp corner.

An opening 402 into the interior of the C-shaped clip 400 is slot like and has a geometric center line identified by reference numeral 403, and as the clip 400 is constructed, the center line 403 is orthogonal to the bottom 406 of the clip body 404. The opening 402 extends downwardly from top portions 414 and 416 of the sides 410 and 412 to an open interior space 432, the shape of which is reminiscent of the number “8” after being rotated slightly, counter-clockwise as shown. The interior space 432 is reminiscent of the number “8” or is “8-shaped” due to the fact that the interior space 432 has two wire rotation-limiting projections 434 and 436 into the open space 432.

The shapes of the projections 434 and 436 are reminiscent of the overlap or intersection of two ellipses. Two ellipses are drawn over the peripheral surface of the opening 432 in broken lines, partly overlapping each other and identified in FIG. 2 by reference numerals 438 and 440. The ellipses 438 and 440 intersect each other at two cusps or intersection points corresponding to the tips or ends of the wire rotation-limiting projections 434 and 436.

An ellipse is a smooth closed curve which is symmetric about its horizontal and vertical axes. Antipodal points are points that are opposite each other. The distance between antipodal points on an ellipse. “Maxima” are the antipodal points connected by the major axis; “minima” are the antipodal points connected by the minor axis. In FIG. 2, maxima of the drawn-in ellipses 438 and 440 are considered to be the points marked by the number sign, “#” whereas minima are marked the points marked by the plus sign “+.”

The wire rotation-limiting projections 434 and 436 are considered to be located on the peripheral surface of the opening 432, forming part of the peripheral surface and as projecting into the opening 432. The projections are also considered to be located between where maxima “#” and minima “+” of drawn-in “ellipses” 430 and 440 would be located.

Two, joined-together wires are considered to have a minor dimension. Of the two circular-cross section wires 214 and 216 shown in the figures, the diameter of the larger of the two wires 214 and 216 is considered herein to be a “minor dimension.”

The width 442 of the slot-like opening 430 into the interior 432 and the horizontal separation distance 444 between the cusps of the projections 434 and 436 are slightly larger than “minor dimension” of two joined-together wires. Stated another way, the greatest or largest outside diameter of a rim wire 214 or 216 to be captured in the clip 400, is less than the maximum distance 446 between the “minima” (marked with the “+” signs) of the two “ellipses” in order to allow two, joined-together wires 214 and 216 to freely drop through the slot/opening 430.

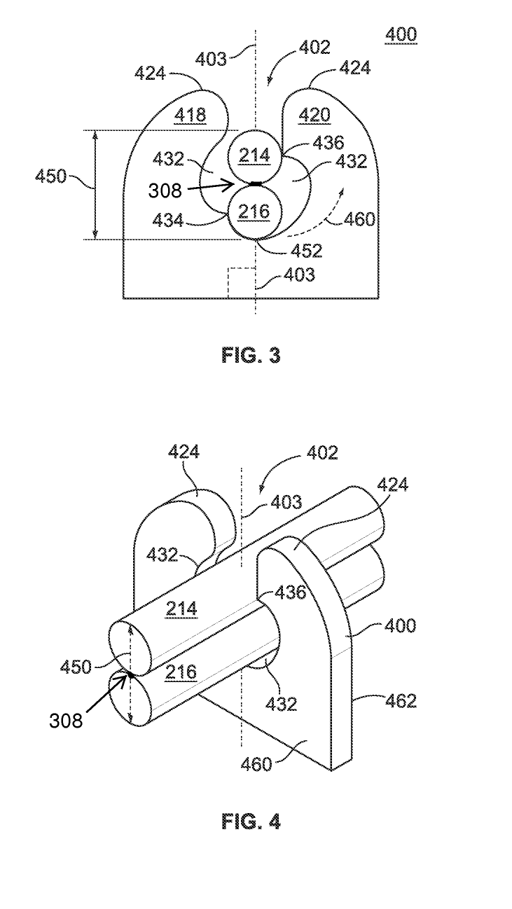

In a preferred embodiment, the dimensions and shape of the interior 432, i.e., the size and shape and arrangement of the “ellipses” 438, 440, and the projection are selected and arranged such that the distance between the two opposing “minima” 446 is slightly greater than the sum of the diameters of rim wires 214 and 216, when they attached to each other as shown in FIG. 3 to provide a slip fit between the opening 402 of the clip 400 and wires to be captured in the clip 400. Providing a slip fit between the joined-together wires 214 and 216 and the slot-like opening 402 allows joined-together basket portion rim wires be dropped into the C-shaped clip in order to assemble a basket portion to a frame portion. The distance identified by reference numeral 446, which is considered to be the distance between the minima “+” is less the sum of two captured wires' diameters in order to prevent rotated wires 214 and 216 from exiting the opening 402.

FIG. 3 is a side view of the clip 400 shown in FIG. 2 and showing two rim wires 214 and 216, welded or otherwise joined to each other lengthwise forming a seam 308 between them. The joined-together wires 214 and 216 are shown in cross section but “upright” in the opening 432. Joined-together wires 214, 216 are considered herein to rotate, and/or be able to rotate around a geometric axis of rotation that extends into and out of the plane of FIG. 3. Such an axis of rotation is preferably located within the seam or line whereat the two wires 214, 216 are joined to each other.

The wires 214 and 216 have substantially circular cross sectional shapes. When joined together, the sum of their combined outside diameters define a “major” dimension 450 corresponding to the sum of their individual diameters. The major dimension 450 is shown as being substantially parallel to the geometric axis 403 of the opening 402. The major dimension 450, is less than the “minima” separation distance 446, (See FIG. 2.) to allow the joined-together wires 214 and 216 to be able to rotate inside the open interior 432, at least to where one or both wires is rotated into one or both of the wire rotation-limiting projections 434 and 436.

In order to assemble the basket 200 to the frame 300, the basket 200 is rotated (counterclockwise as shown in FIG. 13A) such that the major dimension 450 of the two, joined-together wires 214 and 216 is upright or vertical, as shown in FIG. 3. The two wires 214 and 216 are then slid through the opening 402 of the clip 400 until the lower or bottom wire 216 rests on the bottom 452 of the opening 432. Since the major dimension 450 of the joined-together wires 214 and 216 is less than the “diameter” of the opening 432, which in FIGS. 2 and 3 is the “minima” separation distance 446, the joined-together wires are able to rotate in the opening 432 (counterclockwise as shown) until one or both of the upper wire 214 and the lower wire 216 is stopped from further rotation by one or both projections 434 and/or 436. The major dimension 450 greatly exceeds the width of the opening 402. It also exceeds the horizontal separation distance 444 between the projections. Rotation of the joined-together wires 214 and 216 in the opening 432 of the clip 400 thus locks or captures the wires 214 and 216 and the clip 400 to each other, preventing them from rotating further and from moving vertically or horizontally relative to each other.

FIG. 4 is a perspective view of the same clip 400 and wires 214 and 216. The two wires 214 and 216 can be seen extending through both sides 460, 462 of the clip. The wires 214 and 216 are shown as being upright in the open interior 432 after having been slid through the opening 402. When the joined-together wires 214 and 216 are rotated (counterclockwise as shown), outside surfaces of the wires will be stopped from further rotation when the wires engage the projections 434 (not visible) and 436. Rotated wires 214, 216 and the clip 400 will thus be locked together, preventing the wires from moving upward, downward, forward and backward relative to each other.

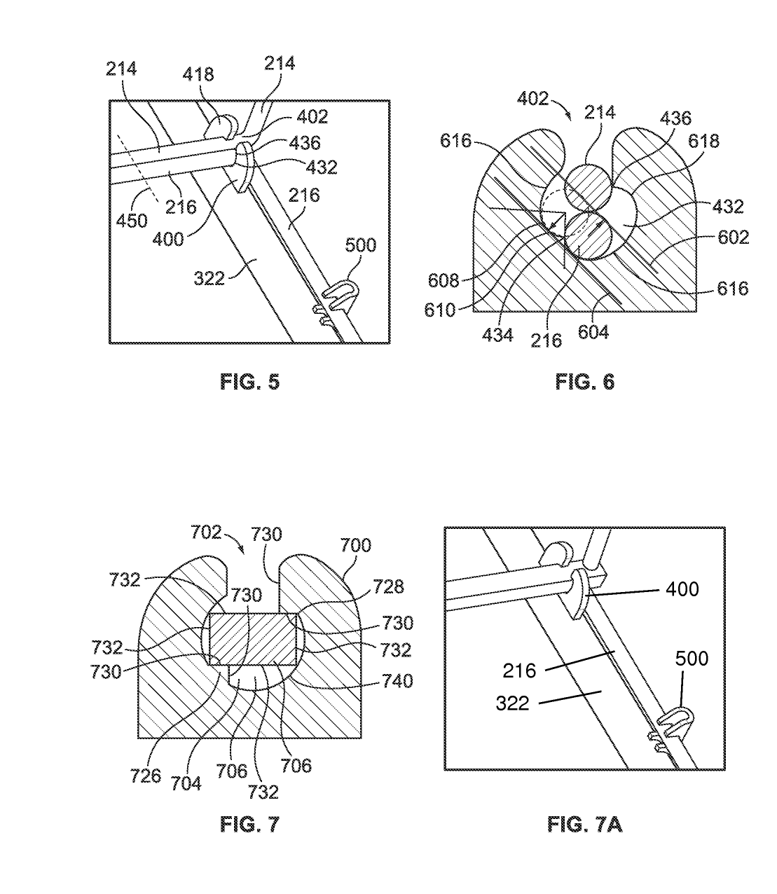

FIG. 5 is a perspective view of the clip 400, attached to a horizontal basket-supporting tube portion 322 of the frame 300 shown in FIG. 1. The clip 400 is also shown with the two, joined-together basket rim wires 214 and 216 lying horizontally, i.e., with their major dimension 450 substantially parallel to the tube portion 322 after being rotated (clockwise as shown) in the opening 432 of the clip 400. The exterior surfaces of both wires 214 and 216 rest against the two wire rotation-limiting projections 434 and 436 into the open space 432 (434 not visible in FIG. 5). Since the wires 214 and 216, which are attached to the basket 200, are locked into the clip 400 and since the clip 400 is attached to the basket supporting portion 322, the rear of the basket 200 is thus “rotatably” locked to the frame 300 by the clip 400.

FIG. 6 is another side view of the clip 400 with the two joined-together rim wires 214 and 216 oriented “upright,” i.e., with their major dimension 450 being vertical. Two datum lines 602 and 604 are drawn parallel to each other and tangent to the surface of the bottom wire 216. The two datum lines 602 and 604 are also tangent to the surface of a drawn-in circle 606, the diameter of which is therefore equal to the diameter of the bottom wire 216.

An arc of the drawn-in circle identified by reference numeral 608, is coincident with a corresponding portion 610 of the left-hand projection 434 into the open interior 432. That portion 610 of the projection 434 will thus “engage” or meet and thus oppose the top wire 214 when the joined-together wires 214 and 216 rotate counterclockwise in the open interior 432. A corresponding portion 618 of the opposite projection 436 will “engage” the bottom wire 216 when the joined-together wires 214 and 216 are rotated. The portions 610 and 612 of the projections 434 and 436 that engage joined-together wires 214 and 216 are considered herein to be rim wire engagement surfaces. They limit the rotation of rim wires in the open interior 432 of the locking clip 400. In a preferred embodiment they limit rotation of joined-together rim wires to be less than ninety-degrees. The length of a wire engagement surface 610 and 612 is preferably at least about one-fourth up to about one-third the circumference of a rim wire 214 or 216.

The location of the projections 434 and 436 around the periphery 616 of the opening 432 will determine the angle of rotation through which the joined-together wires 214 and 216 are able to rotate in the opening 432. The locations of the projections 226 and 228 around the periphery 610 will thus determine whether the portion of the rim wires 214 and 216 will be in torsion when the basket 200 is rotated to its attached position. The locations of the projections 226 and 228 around the periphery 610 will also determine whether a horizontal rim wire 216 extending forward from the rear clip 400 to a front clip 500 will be subjected to bending.

FIG. 7 is a side view of an alternate embodiment of a clip 700, configured to be attached the frame 300 and by which a basket 200 can be clipped to the frame 300 without welding. The clip 700 has a substantially C-shaped cross section. A slot 702 leads into an open interior space 704. A flat bar 706 having a substantially rectangular cross section is dropped down the slot 702 and rotated counterclockwise. The clip 700 is formed to have wedge-shaped projections 722 and 726. The faces 730 of the projections 722 and 726 are at right angles to each other. The bar 706 is shown after having been rotated ninety degrees counterclockwise in the open interior space 704. The horizontal orientation is effected by the locations of the projections 722 and 736 around the periphery 740 of the open interior space 704. The planar surfaces 732 of the bar lie flat against the projections 726 and 728. The projections thus stop the bar 706 from rotating in the interior open space 704 locking the bar and clip together.

Referring again to FIG. 1, four clips attach the basket portion 200 to the frame portion 300. The rear clips 400 are C-shaped clips described above and shown in FIGS. 2-7. The two front clips 500 are described below.

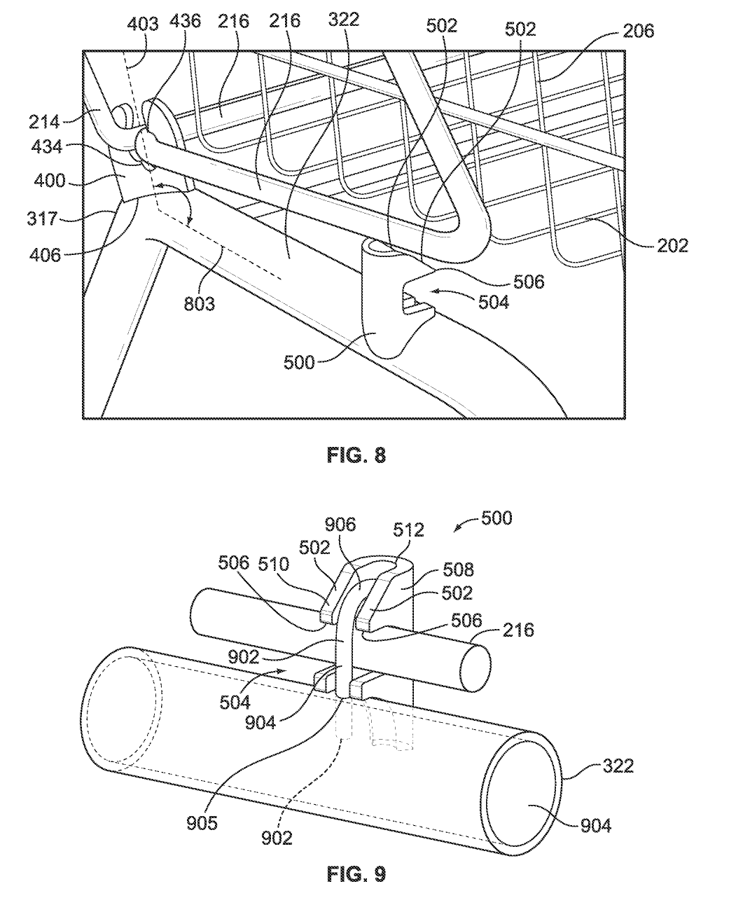

FIG. 8 is a perspective view of a preferred embodiment of front clip 500 for attaching a wire basket 200 to substantially horizontal basket-supporting tube portions 322 and thus to a frame 300. The two joined-together rim wires 214 and 216 lie substantially horizontal in the rear clip 400 and are thus locked in the clip 400.

The bottom 406 of the rear clip 400 is attached to the rear corner 317 such that the center line 403 of the clip 400 is inclined at an angle 803 relative to the tube 322. The angle 803 between the center line 403, and thus the slot-like opening 402, is referred to as a rear clip mounting angle 803 and is measured between the center line 403 of the opening 402 and a central axis 335 of the tube 332.

The clip mounting angle 803 as well as the locations of projections 434, 436 and/or 726 and 728, around the periphery of an interior opening of the clip 400, determine the amount of bending, if any, that will be necessary for the rim wire 216 to engage the front clip 500. The angle 803 and the locations of the projections thus determine at least part of the force necessary to lock the rim wire 216 into the front clip 500.

In FIG. 8, the rim wire 216, which that is to be locked into position in the rear clip by one or more of the aforementioned protrusions, is bent clockwise or forwardly, from the rear clip 400 to reach downwardly to where it just makes contact with one of two inclined surfaces 502 of the front clip 500, below which is a slot or notch 504. The inclined surfaces 502 are considered to be rim wire “followers.”

A follower is believed to be considered a machine part that receives motion from another part. As used herein, a follower” is a surface that urges a rim wire into a rim-wire receiving slot or notch in a front clip, such as the notch 504 in the front clip 500. In FIG. 8, the inclined surfaces 502 urge a rim wire 216 laterally as the rim wire 216 is also urged downward over the surface 502. When the rim wire 216 travels past the end 506 of the inclined surface 502, the wire will have been displaced laterally (not past its elastic limit) such that the stiffness of the rim wire 216 causes the rim wire 216 to snap back to its original shape and thereby latch itself into the notch 504 located just past the end 506 of the follower 502.

The “stiffness” of a rim wire is believed to depend on the rim wire's flexural rigidity, which is considered to be the product of the wire's moment of inertia and its modulus of elasticity. The moment of inertial depends on the wire's cross sectional shape. The modulus of elasticity will depend on the material from which the wire is made. The force required to deflect a wire to engage a clip 500 will also depend on length of a rim wire and where a force is distributed or applied to the wire along its length. In the figures, the rim wires 214 and 216 holding the basket together are solid whereas the tube 304 from which the frame 300 is constructed is hollow. The rim wires and the tube will thus have different moments of inertia due to their construction as well as their respective diameters.

FIG. 9 is a perspective view of the front clip 500 viewed from the rear of the basket 200. The clip 500 is comprised of the two inclined surfaces 502, which are formed as part of opposing sidewalls 508 and 510. The sidewalls are also formed to have cut-outs that form a notch 504 to receive a rim wire. The sidewalls 508 and 510 are joined together by a curved intermediate section 512.

FIG. 9 also shows the rim wire 216 after it has been forced down the inclined surfaces 502 and has snapped into the notch 504. A locking pin 902, having a shape reminiscent of an inverted Arabic letter “J,” has a relatively straight “shank” portion 904 that extends downwardly and through a hole 905 formed into the tube 322. A hook portion 906 attached to or formed from the shank 904 of the locking pin 902 “clamps” over the rim wire 216 after the rim wire 216 is “seated” in the notch 504. The locking pin 902 prevents the rim wire 216 from being removed from the notch 504.

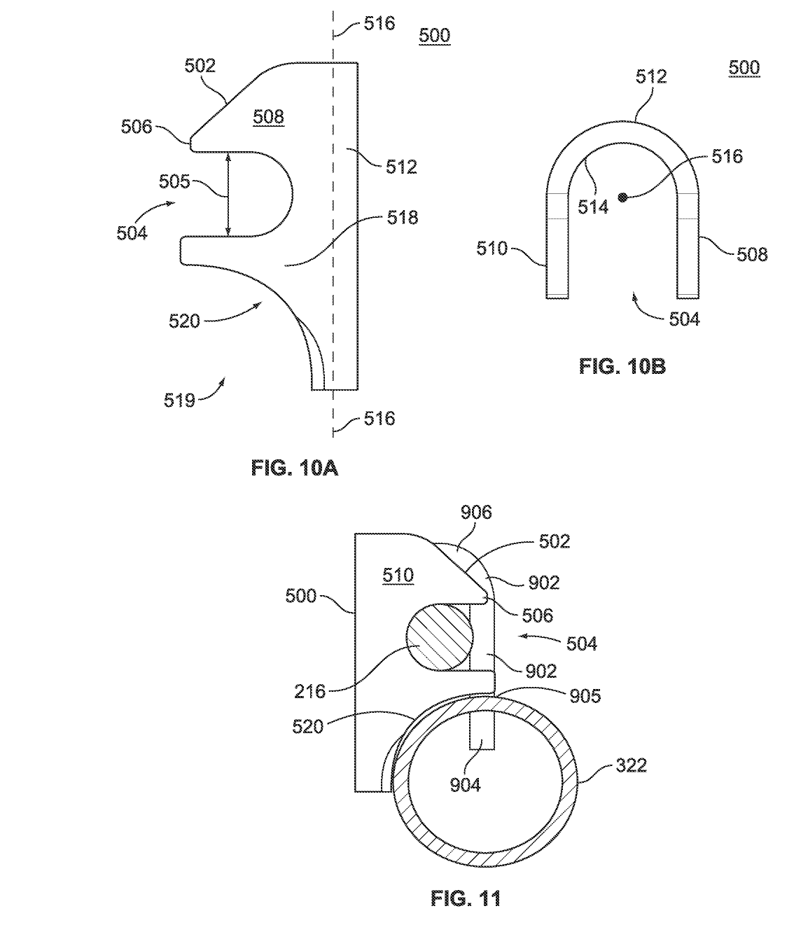

FIG. 10A is a side view of the front locking clip 500. FIG. 10B is a top view of the clip 500. In a preferred embodiment, the sidewalls 508, 510 and the intermediate section 512 between them are formed by stamping a relatively heavy-gauge metal. In FIG. 10A, the sidewalls 508 510 and the intermediate section 512 imbue the clip 500 with a shape reminiscent of a “half-pipe.” When viewed from the top (See FIG. 10B.) the clip 500 has a shape reminiscent of the Arabic letter “U.” The clip is thus considered to be “U-shaped.”

The inside surface 514 of the intermediate section 512 is substantially equidistant from a geometric axis 516 that extends parallel to the sidewalls and the intermediate portion. The bottom portions 518 of the walls 508 and 510 are also formed to have a cut-out section 519 having an inside radius 520 that matches the radius of curvature of a pipe or tube to which the clip is to be attached. The notch 504 has a height dimension 505 (See FIG. 10A.) selected to be greater than the outside diameter of a rim wire to be captured therein.

An alternate embodiment of the clip 500 has sidewalls 508 and 510 joined to each other by a flat or planar intermediate section. Such a clip is nevertheless considered to be U-shaped. The notch 504 is also considered to be “C-shaped.”

In FIG. 8, the inclined surfaces 502 that receive a downwardly moving rim wire 216, displace or translate the rim 216 wire laterally or sideways as the rim wire 216 continues to move downwardly. Each inclined surface 502 is thus considered herein to be a “follower” because they receive motion of a rim wire 216 and direct the rim wire 216 to the rim wire engagement slot or notch 504.

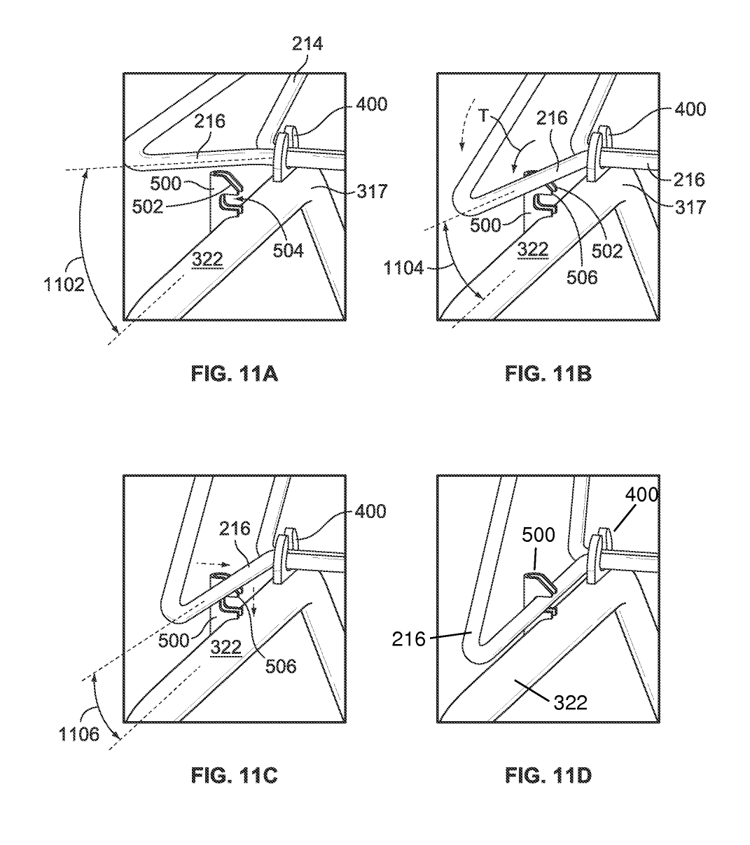

FIGS. 11A-11D depict the engagement of a rim wire 216 into the a rim wire receiving notch 504 of the front clip 500. FIGS. 11A-11D thus depict at least part of the steps of attaching a basket 200 to a frame 300.

In FIG. 11A, the basket rim wires 214 and 216 are both rotatably locked into the rear clip 400. A basket (not shown) to which the rim wires 214 and 216 are attached, is rotated forward, i.e., toward the front of the frame 300, until the rim wires 214, 216 rotate in the rear clip 400 until at least one of them engages one or more wire rotation-limiting projections inside the rear clip 400, stopping the rotation of the two wires 214 and 216 in the rear clip 400. (See FIG. 3 and See FIG. 7.) The rim wire 216, which rests against the rotation limiting projections in the rear clip 400 rests at an angle 1102 relative to the tube 322. The resting angle 1102 is determined by the location of the projections around the periphery of the rear clip 400 as described above as well as the location of where the clip 400 is attached to the tube 322 or the corner 318 and thus the angle of the rear clip's slot-like opening 402 relative to the tube 322.

FIG. 11B depicts the rim wire 216 urged from the angle 1102 shown in FIG. 11A, downward toward the substantially horizontal basket-supporting tube portion 322 and the front clip 500. The angle 1104 between the rim wire 216 and the tube 322 is smaller than the resting angle 1102.

The portion of the wire 216 that extends forward from the rear clip 400 bends downwardly to move from the angle 1102 shown in FIG. 11A to the angle 1104 shown in FIG. 11B. A horizontal portion of the wire 216 that is between the rear clip 400 and the forwardly-extending portion of the wire 216 will also twist when the wire 216 is urged downwardly toward the front clip. The portion of the rim wire 216 extending forward from the clip is thus subjected to a bending moment whereas part of the rim wire 216 in front of the clip is in torsion, T. Locking a basket 200 to a frame 300 thus requires a rim wire to be bent downward after it passes through the rear clip 400 and twisted.

The force required to lock the wire 216 into the front clip 500 will depend on factors that include the wire's cross sectional shape or its moment of inertia, the wire's modulus of elasticity and the wire's length forward of the rear clip 400. The force required to twist the wire portion in front of the clip will depend on where a downward force is applied to the wire 216 along the tube 322, the wire's shear modulus and its polar moment of inertia.

In FIG. 11C, the rim wire 216 is moved even farther downward to an even smaller angle 1106. In FIG. 11C, however, the rim wire 216 is moved laterally inward responsive to the downward movement of the wire 216 over the inclined surfaces 502 of the clip 500. Moving the rim wire 216 from the angle 1104 in FIG. 11B to the angle 1106 in FIG. 11C requires additional force due to the increased bending of the wire around the rear clip 400.

In FIG. 11D, the rim wire 216 has travelled past the bottom 506 of the inclined surfaces 502 that comprise a follower. The rim wire 216 is chosen to be relatively stiff such that when the rim wire 216 travels past the bottom 506 of the follower, it snaps outwardly (as shown in FIG. 11D, into the rim wire receiving notch 504. The wire exerts an upwardly-directed force on the front clip 500 due to the bending moment that was required to drive the rim wire 216 downward from the resting position shown in FIG. 11A.

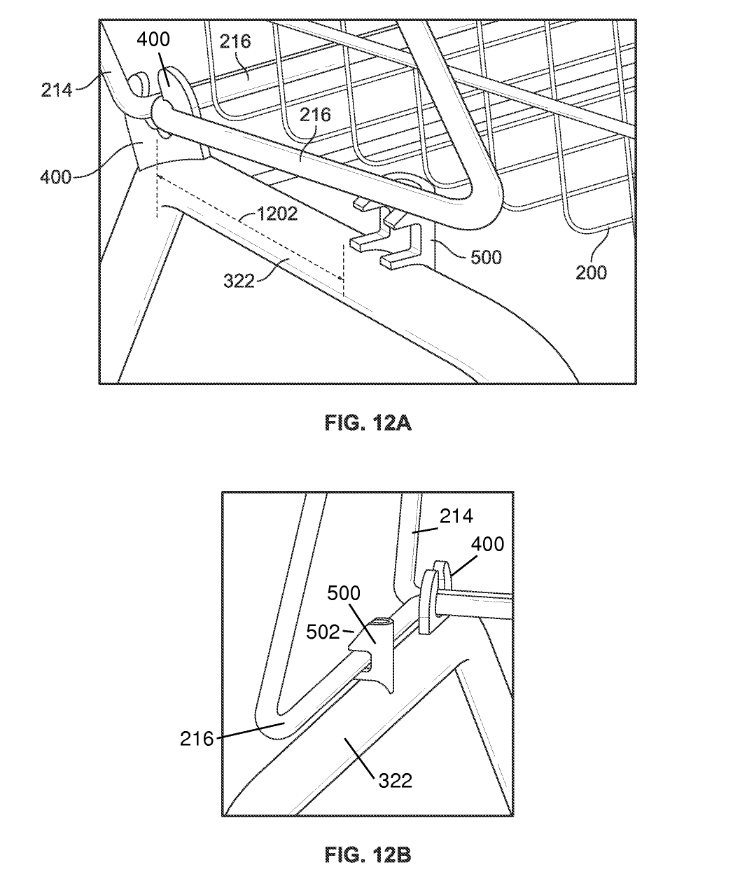

FIG. 12 shows the orientation of a front clip 500 “reversed.” The notch 504 and the U-shaped channel face outwardly. The distance from the rear clip 400 to the front clip 500 is also less than the distance between the rear clip 400 and the front clip 500 shown FIG. 11A-11D.

FIGS. 13A and 13B and the description above depict steps of assembling the wire basket shown in FIG. 1. In FIG. 13A, the basket is rotated or held at an angle 1302 relative to the substantially horizontal basket-supporting tube portions 322. As described above, the angle 1302 at which the basket needs to be held to allow the joined-together rim wires 214 and 216 to enter the slot-like opening 402 of the rear clip 400 will depend on the inclination of the clip 400 and its opening 402, the connection between the two wires 214 and 216, the angle θ between the first rim wire 214, which defines the back 210 of the basket 200 and the second rim wire 216, which defines the bottom 202 of the basket 200.

After the joined-together rim wires 214 and 216 are resting in the opening of the rear clips 400, the basket 200 is rotated forward as described above to the “down” position shown in FIG. 13B. Force required to rotate the basket 200 will depend on the location of the wire rotation-limiting projections in the clips, the angle at which the rear clips 400 are attached to the frame but perhaps mostly the stiffness of the rim wires. The stiffness of the rim wire 216 and the angle through which it was rotated to engage the front clip will determine whether an upward force is applied to the front clip 500 by the rim wire 216.

While the preferred embodiment of the basket 100 uses two rear clips 400 and two forward clips 500, alternate embodiments of the basket 100 include using one rear clip and three or more rear clips 400. Similarly, a single front clip can also lock the basket 200 to the frame in the down position shown in FIG. 13B.

The front clip 500 described above employs a substantially planar surface as a rim wire follower. Alternate embodiments of a clip having essentially the same body use a non-planar or curved surface. State another way, the planar surface of the follower can be curved to be concave or convex.

For purposes of claim construction, the term “wire” should be construed to include a slender, elongated rod having a cross sectional shape that is substantially circular or round. A “wire” thus has a diameter considered herein to be the length of a chord passing through the center of round or circular cross section wire.

The term “wire” should also be construed to include elongated rod having an elliptical or “oval” cross section. The “diameter” of an elliptical-cross section wire is considered herein to be the length of the major axis of the ellipse-shaped cross section. The “major dimension” of two, elongated rods with elliptical cross sections that are joined together would thus be the sum of the two major axes of the two ellipses.

“Wire” also includes elongated rod having a rectangular cross section, wherein a square is a special case of a rectangle. As used herein, the “diameter” of a wire having a rectangular cross section is considered to be largest dimension of a rectangle. The “major dimension” of a rectangular wire is thus considered to be the greatest dimension of the cross section.

Those of ordinary skill in the art will recognize that the foregoing description is for illustration only. The true scope of the invention is set forth in the following claims.

What is claimed is:

1. A clip for attaching a substantially horizontal rim wire of a basket to a basket support member, the clip being comprised of:
a clip body (body);
a rim wire receiving notch formed into the body, the notch being comprised of an opening through a first side of the body, the opening facing laterally; and
a rim wire follower comprised of a surface extending outwardly from the first side of the body, the rim wire follower being configured to urge a substantially horizontal rim wire traveling over the surface to deflect sideways in a first lateral direction away from the first side and snap into the rim wire receiving notch.

2. The clip of claim 1, wherein the surface is comprised of a substantially planar inclined surface having a leading edge.

3. The clip of claim 1, further comprised of a locking clip configured to hold the rim wire in the rim wire receiving notch.

4. A clip for attaching a rim wire of a basket to a frame, the clip being comprised of:
a clip body (body) defining a wall comprised of a rim wire follower;
a rim wire receiving slot formed in the wall;
the rim wire follower being configured to:
urge a substantially horizontal rim wire moving vertically over the rim wire follower to deflect laterally in a first direction away from the intermediate section, and at a terminal end of the rim wire follower, deflect laterally in a second direction that is toward the intermediate section and into the rim wire receiving opening in the wall.

5. The clip of claim 4, wherein the follower is configured to move a downwardly-moving wire.

6. The clip of claim 4, wherein the rim wire has a substantially circular cross section and a diameter, and wherein the receiving slot has a width greater than rim wire diameter.

7. The clip of claim 4, wherein the clip body is comprised of:
a section of a substantially U-shaped channel, the substantially U-shaped channel comprised of first and second sidewalls joined to, and separated from each other by, an intermediate section between them, the section of the substantially U-shaped channel having a length dimension that is substantially parallel to a geometric center line of the substantially U-shaped channel, the geometric center line also being substantially parallel to the sidewalls and the intermediate section;
a first rim wire receiving opening formed in the first sidewall;
a second rim wire receiving opening formed in the second sidewall, the first and second rim wire receiving slots being formed into the first and second sidewalls to face each other;
a rim wire follower attached to and extending away from at least one of the first and second sidewalls, the rim wire follower having leading edge at the at least one of the first and second sidewalls and a terminal end laterally separated from the sidewalls.

8. The clip of claim 7, wherein the intermediate section is substantially planar between the first and second sidewalls and between the first and second ends.

9. The clip of claim 7, wherein the intermediate section has a convex curvature that is continuous, at least between the first and second sidewalls.

10. The clip of claim 5, further comprised of a lock configured to oppose first lateral direction movement of a rim wire in the first and second rim wire receiving openings.

11. The clip of claim 4, wherein the lock is a pin extending through the rim wire follower.

12. A two-part shopping cart assembly having a wire basket portion (basket) and a basket supporting frame portion (frame), the basket being additionally comprised of first and second rim wires attached to the basket portion, the rim wires having a substantially horizontal portion and a first moment of inertia, the frame being comprised of a basket support member having a second moment of inertia, the clip being comprised of:
a body having a rim wire receiving slot, having a lateral-facing opening; and
follower portion, the follower portion configured deflect a rim wire laterally responsive to a downward movement of the rim wire over the follower, and to direct the downward moving rim wire to the lateral-facing opening.

13. The shopping cart of claim 12, wherein the follower portion is an inclined plane.

14. The shopping cart of claim 12, wherein the follower portion is curved and has a positive camber.

15. The shopping cart of claim 12, wherein the lateral-facing opening faces a side wall.

16. The shopping cart of claim 12, further comprised of a locking clip through the follower portion, the locking clip being configured to retain the rim wire in the open center portion responsive to lateral bending in the first lateral direction.

17. The shopping cart of claim 12, wherein the second moment of inertia is less than the first moment of inertia.
